(19) United States
(12) Patent Application Publication
(10) Pub. No.: US 2020/0408398 A1
(43) Pub. Date: Dec. 31, 2020

(54) MODULAR ENCAPSULATED LED LIGHTING WITH INTEGRATED HEAT SINK

(71) Applicant: Ryan P. Hanslip, San Francisco, CA (US)

(72) Inventor: Ryan P. Hanslip, San Francisco, CA (US)

(21) Appl. No.: 16/912,829

(22) Filed: Jun. 26, 2020

Related U.S. Application Data
(60) Provisional application No. 62/868,424, filed on Jun. 28, 2019.

(51) Int. Cl. F21V 29/70; F21S 2/00; F21V 23/00; F21V 31/00; H05B 45/10; H05B 47/175

(52) U.S. Cl. CPC F21V 29/70; F21S 2/005; F21V 23/004; F21Y 2115/10; H05B 45/10; H05B 47/175; F21V 31/005

(57) ABSTRACT

Systems and methods for LED lighting, such as LED lighting used in architectural accent lighting systems. In one embodiment, systems and methods of use of modular encapsulated LED lighting with integrated heat sinks is disclosed. In one aspect, the modular, encapsulated LED lighting with integrated heat sinks is flexible and/or cuttable.

### CROSS-REFERENCE TO RELATED APPLICATION

This application is a nonprovisional patent application of and claims the benefit of U.S. Provisional Patent Application No. 62/868,424, filed Jun. 28, 2019 and titled “Modular Encapsulated LED Lighting with Integrated Heat Sink,” the disclosure of which is hereby incorporated herein by reference in its entirety.

### FIELD

The disclosure relates generally to systems and methods involving light emitting diodes (LED) lighting, and specifically to systems and methods of use of modular encapsulated LED lighting with an integrated heat sink.

### BACKGROUND

Twenty-first century architectural accent lighting has evolved from inexpensive rope lights into high-tech, dynamic light emitting diode (LED) lighting systems. LED lamps are increasingly replacing incandescent lamps because of lower energy consumption, increased efficiency and longer lifetimes of the lamps. Low-intensity LEDs can provide efficient luminosity without requiring excessively large heat sinks. For low power LEDs, heat can be dissipated through multi-layered printed circuit board. The heat dissipation therethrough is normally sufficient to keep the LED junction temperature under the maximum rated value set by the manufacturer. However, increasing power and LED intensity requires an external sink for dissipating heat which cannot be adequately channeled through the printed circuit board and lamp base. Heat can shorten the lifespan and damage LED diodes.

Existing LED lighting systems limit the light output (brightness) of encapsulated LED circuit boards, among other things, due to inadequate heat dissipation. With mounting of LEDs in large arrays to provide increasing luminosity, use of numerous densely packed LEDs becomes increasingly difficult because of the need to provide large heat sinks to remove heat, without detracting from the appearance of the lamps and avoiding possibly blocking some of the emitted light. The self-contained nature of LEDs, which are usually powered through electronic circuits having an outside power source, require that the heat sink efficiently remove heat from the circuits and from the LED itself. Especially when higher intensity LED lamps are used, the heat dissipation requirements increase and heat sinking properties of various thermally conductive materials have been relied on in providing the heat sink capacity for concentrated arrays of LEDs.

Thermal management of LEDs is generating intense scrutiny in the field. Since common FR4 circuit boards do not provide a high level of heat dissipation, it has been found that aluminum is a good heat sink material. For example, described in U.S. Pat. No. 7,192,155 (incorporated by reference in entirety for all purposes), an aluminum base plate is used for mounting LEDs. This type of heat sink removes heat from the integrated circuits associated with the LEDs and acts to transfer the heat from the base to an outer housing which acts as the external heat sink for removing heat. In another design, U.S. Pat. No. 9,797,583 entitled “LED Lighting with Frangible Circuit Board and Heat Sink Mount” (incorporated by reference in entirety for all purposes) describes an LED strip lighting fixture having an array of LEDs mounted on a frangible rigid aluminum base having predetermined points of weakness, whereby the rigid base may be broken at the predetermined points of weakness.

It has also been found desirable in the manufacture of LED arrays to provide circuitry that is capable of being subdivided by manual methods without affecting the ability to connect the underlying circuitry to a source of power and to control mechanisms. U.S. Pat. Appl. No. 2013/0083533 to Janik (incorporated by reference in entirety for all purposes) employ's a base for an array of LEDs that is frangible so that it can be folded into a space for use in a lamp that resembles in form a normal incandescent bulb. Janik describes dissipating heat in higher intensity LED lamps, individual LEDs mounted on a thermally conductive medium, such as an aluminum plate. However, mounting LEDs on a plate of even nominal thickness will reduce the view angle of the emitted light, resulting in a noticeable band of lower intensity light when projected on a nearby surface. Thus, the need for a frangible board that permits the folding into a configuration that fits into the space available.

Another method use of an array of LEDs is in a line array along a strip or elongated fixture which has a variable length. Architectural lighting applications call for long, seamless linear lighting fixtures that may be visible in plain sight. Some products available in the form of FR4 fiberglass/epoxy rigid circuit boards can be manufactured in varying lengths and can be assembled with soldered pins in an additive fashion to make the arrays in desirable lengths. This type of rigid light engine assembly is sometimes prone to connection failures between the sections due to shock or vibration in transit during installation and through rugged use. An increase in labor time and costs for assembly results in many instances because the junctions must be soldered by hand. The many solder junctions and mechanical electrical connections can also create a weak point in the circuit. Metal linear fixtures may expand and contract as the light array warms up and cools down, fatiguing solder joints over time and causing premature failures as well as other problems with noise and ingress protection.

A linear array should ideally be suitable for direct view applications (diffused light versus pixilation or ‘dots’) and should also be able to be cut to desired lengths to fit millwork, coves, shelving, etc. so as to mitigate the appearance of dead spots without light. Thin, flexible circuit boards are currently employed for these applications. So called “tape lights,” in which strips of somewhat flexible tape on which LEDs are mounted, serve this function, but several drawbacks exist with such use. Among these are the inability to adequately remove heat from mid-power LEDs because these flexible materials, although allowing to be cut to a desired size by, for example scissors, the heat sink capabilities of such flexible tape materials remain wanting. The requirement for a fit to size linear array heretofore has not been addressed in the context of high intensity LED arrays that generate a significant amount of heat so as to impair the operation of the devices with continuous use.

Many applications of LEDs require encapsulation so as to provide LED protection from elements, such as moisture and dust. However, encapsulated LED systems can exacerbate heat dissipation design challenges and negatively impact lighting characteristics, such as light output (brightness).

What is needed is a modular encapsulated LED lighting system with integrated heat sinks which is flexible and/or cuttable that overcomes the shortcomings of existing LED lighting systems. This disclosure provides such a modular encapsulated LED lighting system. In one embodiment, the LED lighting system is encapsulated by extruded silicone and one or more LEDs are mounted onto a frangible or cuttable aluminum circuit board to create a modular, flexible, linear fixture with a flexible, integrated heat sink. Such an LED lighting system provides many benefits, such as the ability to cut or break the aluminum circuit board so as to modifying lighting system lengths to fit design conditions, such as architectural conditions. In one feature, the heat sink greatly increases the maximum light output of the encapsulated module while keeping the operating temperature of the circuit board within an acceptable temperature range.

### SUMMARY

The present disclosure can provide several advantages depending on the particular aspect, embodiment, and/or configuration.

Generally, systems and methods of use of modular encapsulated LED lighting with integrated heat sinks, such as LED lighting used in architectural accent lighting, are disclosed. In one embodiment, a modular encapsulated LED lighting system with integrated heat sinks which is flexible and/or cuttable is disclosed.

In one embodiment, a modular encapsulated lighting system with integrated heat sink is disclosed, the system comprising: a light emitting diode (LED); a first IC board extending in a longitudinal direction from a first end having a first end engagement portion to a second end having a second end engagement portion, the LED disposed on a first IC board surface of the first IC board and presenting a set of LED exposed surfaces; and an encapsulation material disposed on the set of LED exposed surfaces and further disposed on a first IC board surface area surrounding the set of LED exposed surfaces; wherein: the first end engagement portion of the first IC board is configured to engage a second end engagement portion of a second IC board and the second end engagement portion of the first IC board is configured to engage a first end engagement portion of a second IC board, the second IC board of substantially similar configuration to the first IC board; and the first IC board receives thermal energy from the LED.

In one aspect, the first IC board surface area is substantially all of the first IC board surface except for the first IC board surface in contact with the LED. In another aspect, the first IC board comprises an aluminum substrate. In another aspect, the first IC board is controlled remotely by a user. In another aspect, the system is configured to communicate with an LED driver comprising a processor, the processor storing a set of multi-channel dim curves comprising a set of control instructions for the LED. In another aspect, a dimmer in communication with the LED driver selects the set of control instructions. In another aspect, the set of control instructions is selectable by a user. In another aspect, the first end comprises a first end contact terminal and the second end comprises a second end contact terminal, the first end contact terminal configured to form an electrical connection with a second end contact terminal of a second IC board and the second end contact terminal configured to form an electrical connection with a first end contact terminal of the second IC board In another aspect, the encapsulation material is extruded silicon and the system is substantially waterproof. In another aspect, the first end engagement portion of the first IC board and the second end engagement of the second IC board form a tongue and groove arrangement when engaged with one another.

In another embodiment, a method of controlling a modular encapsulated lighting system with integrated heat sink is disclosed, the method comprising: providing a modular encapsulated lighting system comprising: a first light emitting diode (LED); a first IC board extending in a longitudinal direction from a first end having a first end engagement portion to a second end having a second end engagement portion, the first LED disposed on a first IC board surface of the first IC board and presenting a set of first LED exposed surfaces; and an encapsulation material disposed on the set of first LED exposed surfaces and further disposed on a first IC board surface area surrounding the set of first LED exposed surfaces; affixing the modular encapsulated lighting system to a light fixture; providing an LED driver comprising a processor, the processor storing a set of multi-channel dim curves comprising a set of control instructions for the first LED; and controlling the first LED with the set of control instructions.

In one aspect, the set of control instructions is selectable by a user. In another aspect, a dimmer in communication with the LED driver selects the set of control instructions. In another aspect, the LED driver is a two channel LED driver. In another aspect, the light fixture is a two channel LED light fixture. In another aspect, the first IC board comprises a substrate substantially made of aluminum. In another aspect, the first IC board operates as a circuit board in communication with the LED. In another aspect, the encapsulation material is extruded silicon. In another aspect, the modular encapsulated lighting system is waterproof.

In yet another embodiment, a modular encapsulated lighting system with integrated heat sink is disclosed, the system comprising: a light emitting diode (LED); a first IC board extending in a longitudinal direction from a first end having a first end engagement portion to a second end having a second end engagement portion, the LED disposed on a first IC board surface of the first IC board and presenting a set of LED exposed surfaces, the first IC board comprising aluminum; and an encapsulation material disposed on the set of LED exposed surfaces and further disposed on a first IC board surface area surrounding the set of LED exposed surfaces, the encapsulated material comprising extruded silicon; wherein: the first end engagement portion of the first IC board is configured to engage a second end engagement portion of a second IC board and the second end engagement portion of the first IC board is configured to engage a first end engagement portion of a second IC board, the second IC board of substantially similar configuration to the first IC board; the first end engagement portion of the first IC board and the second end engagement of the second IC board form a tongue and groove arrangement when engaged; the first IC board receives thermal energy from the LED; and the modular encapsulated lighting system is substantially waterproof.

By way of providing additional background, context, and to further satisfy the written description requirements of 35 U.S.C. § 112, the following references are incorporated by reference in their entireties: U.S. patent application Ser. No. 16/509,173 entitled “Narrow Collimating and Diffusing Optic System for LED Lighting;” U.S. Pat. Nos. 10,378,747 and 10,663,156, both entitled “Field-Configurable LED Tape Light;” and U.S. Pat. Nos. 10,111,294 and 10,383,189, both entitled “Efficient Dynamic Light Mixing for Compact Linear LED Arrays;” and U.S. Pat. Appl. No. 62/909,964 entitled “Subterranean Lighting Power Supply.”

The word “app” or “application” means a software program that runs as or is hosted by a computer, typically on a portable computer, and includes a software program that accesses web-based tools, APIs and/or data.

The phrase “waterproof” means impervious to water.

The phrase “watertight” means closely sealed, fastened, or fitted so that no water enters or passes through.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1A is a perspective view of one embodiment of a modular encapsulated LED lighting system with integrated heat sink;

FIG. 1B is a right-side end view of the modular encapsulated LED lighting system with integrated heat sink of FIG. 1A;

FIG. 1C is a front view of the modular encapsulated LED lighting system with integrated heat sink of FIG. 1A;

FIG. 1D is a top view of the modular encapsulated LED lighting system with integrated heat sink of FIG. 1A;

FIG. 2A is a right-side end view of another embodiment of a modular encapsulated LED lighting system with integrated heat sink;

FIG. 2B is a front view of the modular encapsulated LED lighting system with integrated heat sink of FIG. 2A;

FIG. 2C is a top view of the modular encapsulated LED lighting system with integrated heat sink of FIG. 2A;

FIG. 3 is a top view of one embodiment of a series of modular encapsulated LED lighting systems with integrated heat sink, detailing connections between the systems;

FIG. 4 is a top view of another embodiment of a series of modular encapsulated LED lighting systems with integrated heat sink, detailing connections between the systems;

FIG. 5 is a schematic diagram of one embodiment of a modular encapsulated LED lighting system with integrated heat sink as part of a larger controller-managed lighting system; and

FIG. 6 is a schematic diagram of another embodiment of a controller-managed lighting system using the modular encapsulated LED lighting system.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

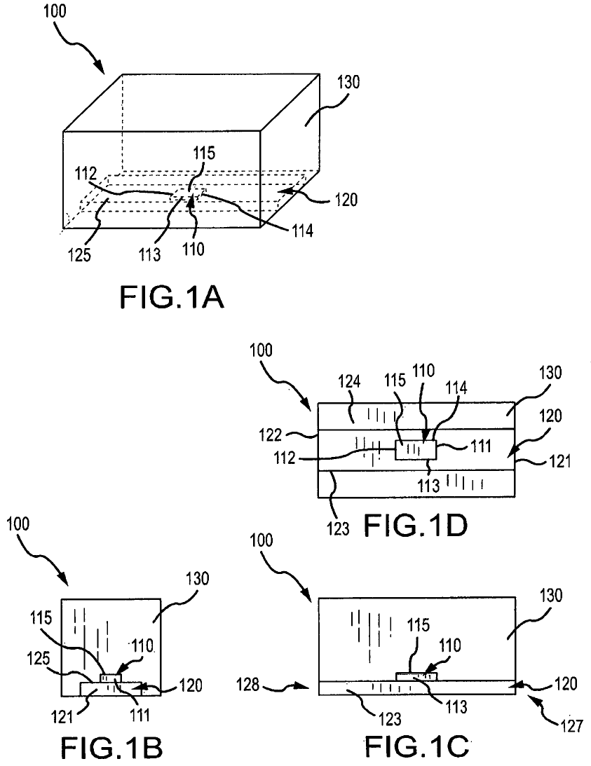

The disclosed devices, systems, and methods of use will be described with reference to FIGS. 1-6. Generally, systems and methods to provide LED lighting, such as LED lighting used in architectural accent lighting systems, are disclosed. In one embodiment, systems and methods of use of modular encapsulated LED lighting with integrated heat sinks are disclosed. In one aspect, the modular, encapsulated LED lighting with integrated heat sinks is flexible and/or cuttable.

With attention to FIGS. 1A-D, a modular encapsulated light emitting diode system with integrated heat sink (the “lighting system”) 100 is depicted. Generally, the lighting system 100 comprises a light emitting diode (LED) 110, an IC board 120 coupled to the light emitting diode 110, and an encapsulation material 130.

The LED 110 is coupled to the IC board 120. For example, the LED 110 may be disposed on or mounted to the IC board 120. The LED 110, when coupled to the IC board 120, has a set of exposed surfaces, e.g. an exposed upper surface and one or more exposed side surfaces. An encapsulated material 130 covers and/or is disposed on top of the LED 110 and the surrounding IC board 120.

The LED 110 is generally in a rectangular shape, although any commercially available shape for the LED is possible, as known to those skilled in the art. The LED 110 has an upper surface 115, a right side surface 111, a left side surface 112, a front surface 113, a rear surface 114, and a lower surface opposite the upper surface 115. The bottom surface engages with the IC board 120 upper surface 125. More generally, the “exposed surface” when referring to a mounted or disposed LED (mounted or disposed on an IC board, for example) are the set of surfaces other than the surface directly engaged with the receiving surface, e.g. other than the portion of the IC board engaged directly with the LED.

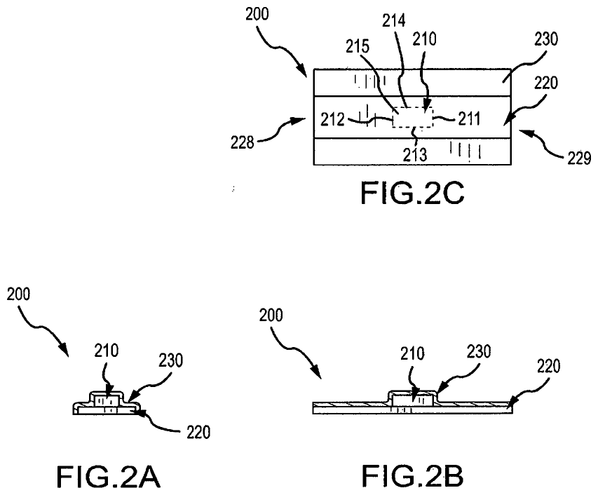

The IC board 120 is generally also of a rectangular shape, although of greater longitudinal dimension than the longitudinal dimensions of the LED 110. Stated another way, the longitudinal measure of IC board 120 is greater than the longitudinal measure of LED 110. The IC board 120 has an upper surface 125, a lower surface opposite the upper surface, a right side surface 121, a left side surface 122, a front surface 123, and a rear surface 124. The IC board 120 also has a first end 228 and a second end 229 (to be described below with respect to FIGS. 2A-C). The IC board comprises a substrate, such as aluminum, which receives the one or more LEDs 110 and other electrical components, e.g. wiring, resistors, etc.

The IC board 120 is configured to receive thermal energy, such as heat, from the LED 110. In one embodiment, the IC board 120 includes an aluminum substrate. In one embodiment, the IC board 120 comprises aluminum. In one embodiment, the IC board 120 includes an aluminum portion. In one embodiment, the IC board 120 includes an aluminum portion, the aluminum portion providing a heat sink to receive heat generated by the LED 110. In one embodiment, the IC board 120 includes a portion which provides a heat sink to receive heat generated by the LED 110. In one embodiment, the IC board 120 includes a substrate, the substrate made of any heat-conducting material known to those skilled in the art.

In one embodiment, the IC board 120 is flexible and/or cuttable. The IC board 120 may be cuttable as described in, for example, U.S. Pat. No. 9,797,583 to Hanslip, as referenced above. More detail as to the flexible and/or cuttable features of the IC board 120 are provided below. In one embodiment, the modular encapsulated light emitting diode system with integrated heat sink 100 is frangible, cuttable, or both frangible and cuttable.

The IC board 120, when coupled to the LED 100, presents an exposed upper surface and one or more exposed side surfaces. As mentioned above, the IC board 120 may comprise additional components, such as wires or other electrical connections, not shown in FIGS. 1A-D but known to those skilled in the art.

The encapsulation material 130 is coupled to the LED 110 and the IC board 120. In one embodiment, the encapsulation material 130 surrounds the LED 110 and the upper surface of IC board 120. In one embodiment, the encapsulation material 130 covers all of the exposed upper and lower surfaces of each of the LED 110 and the IC board 120. Stated another way, the encapsulation material 130 is disposed on the set of exposed surfaces of LED 110 of upper surface 115, right side surface 111, left side surface 112, front surface 113, and rear surface 114. The exposed surfaces of the LED 100 are: upper surface 115, right side surface 111, left side surface 112, front surface 113, and rear surface 114. The encapsulation material 130 is also disposed on an area of the IC board 120 that surrounds the LED 110 and/or that forms a perimeter around the LED 110. Stated another way, the encapsulation material 130 is disposed around the LED and over the LED exposed surfaces. In one embodiment, the encapsulation material 130 covers or encapsulates all exposed surfaces of the IC board 120, to include the one or more disposed LEDs 110.

In the embodiment of FIGS. 1A-D the encapsulation material 130 forms a rectangular cross-section extending the length of the IC board 120 and ending at the length of the IC board 120. The encapsulation material 130 forms a rectangular cross-section extending substantially all of the length of the IC board 120. Note that the encapsulation material 130 extends wider in lateral dimension than both of the IC board 120 and the LED 110. Stated another way, in one embodiment, the encapsulation material 130 forms a rectangular cross-section extending beyond the length of the IC board 120.

In one embodiment, the encapsulation material 130 is extruded silicon. In one embodiment, the encapsulation material 130 is any material known to those skilled in the art to provide encapsulation of an LED.

In one embodiment, the modular encapsulated light emitting diode system with integrated heat sink 100 is waterproof or substantially waterproof. In one embodiment, the modular encapsulated light emitting diode system with integrated heat sink 100 is water resistant or substantially water resistant. In one embodiment, the modular encapsulated light emitting diode system with integrated heat sink 100 is watertight or substantially watertight. In one embodiment, the modular encapsulated light emitting diode system with integrated heat sink 100 is sealed wherein no particles, such as water particles or dust particles, may enter.

FIGS. 2A-C depict another embodiment of a modular encapsulated LED lighting system with integrated heat sink 100. The embodiment of FIGS. 2D-F is similar to the embodiment of FIGS. 1A-D except that the encapsulation material 130 is configured as a sheet rather than a rectangular block. The encapsulation material 130 encapsulates the IC board 120 and the light emitting diode (LED) 110. This configuration provides a number of benefits, to include providing ingress protection while still dissipating heat, such as through the encapsulation material 130 thermally conductive silicone material.

In some embodiments, a series or set of LED 110 are mounted or disposed on the IC board 120. The IC board 120 may be configured of a predetermined length, for example, four inches, but as small as one inch long is possible. Beveled edges may be disposed adjacent a bottom surface at either or both ends of the IC board 120, the bevels extending in the transverse direction to the longitudinal length of the IC board 120. As described above, the IC board 120 may comprise or be formed substantially completely of, a metal having good heat conductive properties, such as aluminum. The nominal thickness of the IC board 120 as measured between upper and lower surfaces may be about ¾ inch, although this may be modified depending on the configuration desired. Also, adjacent each end of the IC board may include one or more posts for electrical connections to the external power source.

In one embodiment, the modular encapsulated light emitting diode system with integrated heat sink interacts with, engages with, or otherwise is in communication with (e.g. may be powered by) any available power supply to include, e.g., the power supply of U.S. Pat. Appl. No. 62/909,964 to Hanslip entitled “Subterranean Lighting Power Supply,” incorporated by reference for all purposes.

The IC board 120, in addition to receiving and securing one or more LEDs 110, may receive or secure integrated circuit components not shown in the set of FIGS. 1-6. For example, IC board may include metallic or metalized leads extending therethrough and providing an electrical circuit between the elements of the system, or electrical resisters, etc. Each of the posts may be provided with an electrical connection to the IC board 120 so as to provide power and control to the circuitry of the IC board 120 and to the other elements of the system. In one embodiment, the power and control is provided from an external network and power supply, such as an electrical grid (not shown) being connected to the posts at installation.

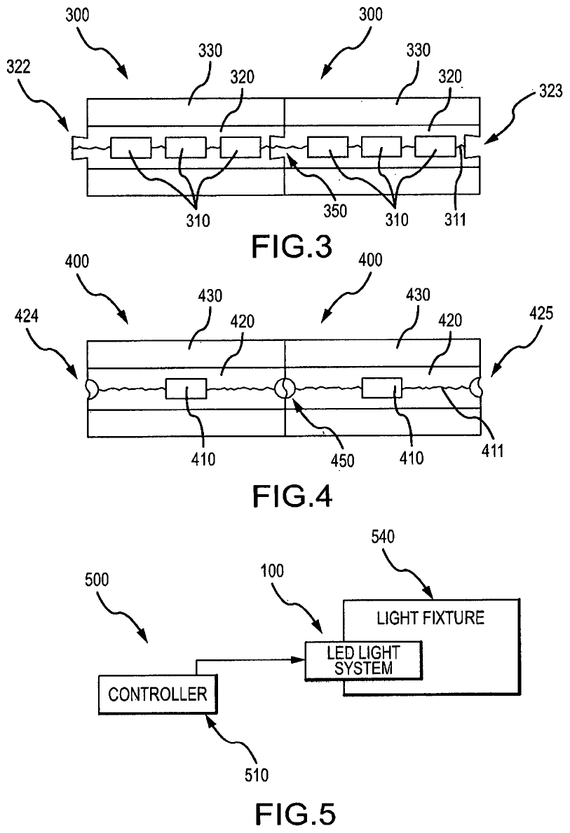

The LED 110 may form an array of LEDs 110 as mounted or disposed on the IC board 120. In one embodiment, an array of LEDs 110 are arranged in an evenly spaced manner (see, e.g. FIG. 3) and connected to the electrically conductive IC board 120 by soldering or other appropriate means. When LEDs 30 are soldered onto the IC board 120, the LEDs 110 are electrically connected to the circuitry of the IC board 120 and comprise part of the circuit of each of a particular module system. The LEDs 110 may be standard commercially available LEDs, such as Citizen CLL 625 type LEDs. Other types of LEDs 110, having different characteristics and specifications, may be used if necessary to provide for different applications, as needed, and a person having sufficient skill in the art can easily replace and substitute appropriate ones of the LEDs as needed for a specific application. In one embodiment, the modular encapsulated light emitting diode system with integrated heat sink forms a linear LED and/or linear lighting system.

The one or more LEDs 110 of the modular encapsulated LED lighting system with integrated heat sink system are directly mounted onto the upper surface of the IC board 120 and provide a mounting surface that is in direct interfacing relationship with the surface of the IC board 120. This interface provides for direct heat conduction from each of LEDs 110 to the surface of the IC board 120; when the IC board 120 is of an electrically-conductive material, e.g. aluminum, the IC board 120 provide a sufficient amount of heat sink capability to the LED(s) to maintain the temperature thereof in an operational range that retains the long term life of the LED(s). The thickness of the IC board 120 has sufficient dimensions to wick off the excessive heat generated by the most intense of commercially used mid and high-power LEDs used in lighting of this type. Additional customization is possible to provide for thicker or thinner IC boards 120 depending on the desired characteristics of the application in which it is desired to install the modular encapsulated LED lighting system with integrated heat sink system.

In some embodiments, an Integrated Circuit (IC) current regulator for providing a continuous steady current throughout the elements of the IC may be provided. The current regulator is important to maintain a steady light intensity, and also to provide the capability of configuring the system to enable it to vary the light intensity as desired by the user.

With attention to FIGS. 2A-C, the LED 210 is generally in a rectangular shape. The LED 210 has an upper surface 215, a right side surface 211, a left side surface 212, a front surface 213, a rear surface 214, and a lower surface opposite the upper surface 215. The bottom surface engages with the IC board 220 upper surface 225.

The IC board 220 has an upper surface 225, and a first end 228 and a second end 229. The IC board extends in a longitudinal direction from the first end 228 to the second end 229.

In one embodiment, the modular encapsulated light emitting diode system with integrated heat sink is fitted with or otherwise engaged with optical components described in U.S. patent application Ser. No. 16/509,173 to Hanslip entitled “Narrow Collimating and Diffusing Optic System for LED Lighting.”

The various embodiments of a modular encapsulated light emitting diode system with integrated heat sink may form a series of systems as provided in FIGS. 3 and 4. Generally, two or more modular and identical (or at least substantially identical) systems may be attached to each other as they would be when manufactured. As these are integral when originally manufactured, the top portions of the IC boards are connected to each other at their ends, that is, one end (e.g. a first end 322) is connected to another end (e.g. a second end 323) of an adjoining basic sectional system, the connected sections able to be separated, through e.g., the connector 350. (See FIG. 3).

With attention to FIGS. 3 and 4, embodiments of a series of modular encapsulated LED lighting systems with integrated heat sink 300, 400 respectively are depicted, detailing connections between the systems 300 and 300, and 400 and 400, to form a linear series of systems. The connections are configured with repetitive connections: connection 350 to connect first IC board of first system 300 with adjacent second IC board of second system 300 of FIG. 3, and connection 450 to connect first IC board of first system 400 with adjacent IC board of second system 400 of FIG. 4. Note that in each of FIGS. 3 and 4, encapsulated material is not shown for clarity; the encapsulated material, in the complete systems, is layered on top of or disposed on top of the LEDs 310 disposed on top of IC boards 320 (FIG. 3) and layered on top of or disposed on top of the LEDs 410 disposed on top of IC boards 420 (FIG. 4). Encapsulated material 330, 430 in each of respective systems 300, 400 is also disposed on top of substantially all or the entirety of the upper surface of respective IC boards 320, 420.

In FIG. 3, a repetitive tongue and groove connection 350 is shown, with male tongue component 322 fitting with female groove component 323. Electrical contact terminals may also be provided on each end of the IC boards 320, meaning a one or more contact terminals may be positioned at each of first end and second end of IC board 320. Stated another way, a first electrical contact terminal may be positioned at or near or adjacent to tongue component 322 and a second electrical contact terminal may be positioned at or near or adjacent to groove component 323. More than one LED 310 may be disposed on IC board 320, as shown in FIG. 3 wherein a sequence of three LEDs 310 are positioned or disposed on the IC board 320. LED electrical connections 311 are also depicted which connect the LEDs and/or provide electrical connection between a sequence of systems 300.

In FIG. 4, a repetitive ying-yang connection 450 is shown, with first ying-yang component 424 fitting with second ying-yang component 425. Electrical contact terminals may also be provided on each end of the IC boards 420, meaning a one or more contact terminals may be positioned at each of first end and second end of IC board 420. Stated another way, a first electrical contact terminal may be positioned at or near or adjacent to first ying-yang component 424 and a second electrical contact terminal may be positioned at or near or adjacent to first ying-yang component 425. LED electrical connections 411 are depicted which connect the LED of each 400 system to an adjacent system 400.

Other repetitive connections between adjacent modular encapsulated light emitting diode systems are possible, such as other repetitive mechanical connections known to those skilled in the art, such as dove tail connections, puzzle-like connections, etc.

In one embodiment, a bottom surface of adjoining IC boards of adjoining systems have beveled edges which provide score lines at each of the respective ends so that the dimension between the apex of the score line and the top surface of the IC board is much smaller than the thickness dimension between the surfaces. Thus, it is easy to break away one system section from the remaining sections, making each of the sections frangible and capable of providing plural system sections having a desired length for any particular application. The scoring allows for the system to be broken by hand, to fit within custom length fixture housings. Custom length fixture housings can be cut to predetermined dimensions at the assembly plant.

FIG. 5 is a schematic diagram of one embodiment of a modular encapsulated LED lighting system with integrated heat sink 100 as part of a controller-managed lighting system 500. The controller-managed lighting system 500 comprises controller 510, modular encapsulated LED lighting systems with integrated heat sink 100, and light fixture 540.

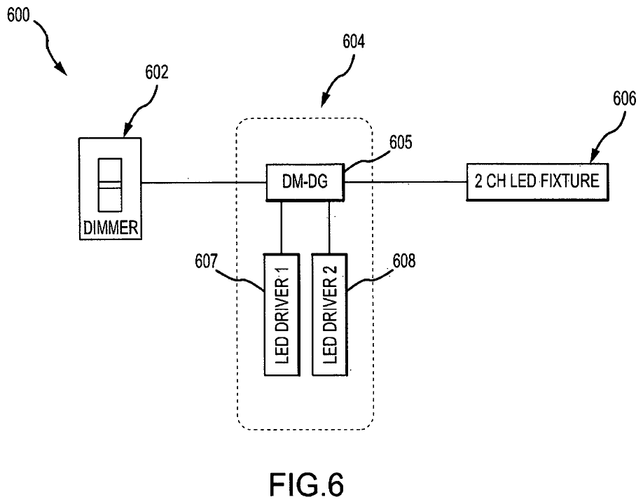

FIG. 6 is a schematic diagram of another embodiment of a controller-managed lighting system 600. The controller-managed lighting system 600 comprises a dimmer 602, LED driver 604, and LED fixture 606. In one embodiment, the LED fixture 606 comprises the modular encapsulated LED lighting system with integrated heat sink 100 described above.

The control schemes and controller devices to control lighting system 100 of FIG. 5 and/or FIG. 6 may be by any known schemes and devices known, to include those described in U.S. Pat. Nos. 10,111,294 and 10,383,189, both to Hanslip and both entitled “Efficient Dynamic Light Mixing for Compact Linear LED Arrays.”

In one embodiment, the controller is an app, and/or the controller interacts with an app.

In one embodiment, the encapsulated material is a thermally receptive material meaning a material which receives thermal energy, thereby drawing away or receiving thermal energy from the LED and/or circuit board. In one embodiment, the encapsulated material is a thermally conductive material.

The exemplary systems and methods of this disclosure have been described in relation to systems and methods involving LED lighting. However, to avoid unnecessarily obscuring the present disclosure, the preceding description omits a number of known structures and devices, and other application and embodiments. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

What is claimed is:

1. A modular encapsulated lighting system with integrated heat sink comprising:
a light emitting diode (LED);
a first integrated circuit (IC) board extending in a longitudinal direction from a first end having a first end engagement portion to a second end having a second end engagement portion, the LED disposed on a first IC board surface of the first IC board and presenting a set of LED exposed surfaces; and
an encapsulation material disposed on the set of LED exposed surfaces and further disposed on a first IC board surface area surrounding the set of LED exposed surfaces;
wherein:
the first end engagement portion of the first IC board is configured to engage a second end engagement portion of a second IC board and the second end engagement portion of the first IC board is configured to engage a first end engagement portion of a second IC board, the second IC board of substantially similar configuration to the first IC board; and
the first IC board receives thermal energy from the LED.

2. The system of claim 1, wherein the first IC board surface area is substantially all of the first IC board surface except for the first IC board surface in contact with the LED.

3. The system of claim 1, wherein the first IC board comprises an aluminum substrate.

4. The system of claim 3, wherein the first IC board is controlled remotely by a user.

5. The system of claim 1, wherein the system is configured to communicate with an LED driver comprising a processor, the processor storing a set of multi-channel dim curves comprising a set of control instructions for the LED.

6. The system of claim 5, wherein a dimmer in communication with the LED driver selects the set of control instructions.

7. The system of claim 5, wherein the set of control instructions is selectable by a user.

8. The system of claim 1, wherein the first end comprises a first end contact terminal and the second end comprises a second end contact terminal, the first end contact terminal configured to form an electrical connection with a second end contact terminal of a second IC board and the second end contact terminal configured to form an electrical connection with a first end contact terminal of the second IC board.

9. The system of claim, wherein the encapsulation material is extruded silicon and the system is substantially waterproof.

10. The system of claim 10, wherein the first end engagement portion of the first IC board and the second end engagement of the second IC board form a tongue and groove arrangement when engaged with one another.

11. A method of controlling a modular encapsulated lighting system with integrated heat sink, the method comprising:
providing a modular encapsulated lighting system comprising:
a first light emitting diode (LED);
a first IC board extending in a longitudinal direction from a first end having a first end engagement portion to a second end having a second end engagement portion, the first LED disposed on a first IC board surface of the first IC board and presenting a set of first LED exposed surfaces; and
an encapsulation material disposed on the set of first LED exposed surfaces and further disposed on a first IC board surface area surrounding the set of first LED exposed surfaces;
affixing the modular encapsulated lighting system to a light fixture;
providing an LED driver comprising a processor, the processor storing a set of multi-channel dim curves comprising a set of control instructions for the first LED; and
controlling the first LED with the set of control instructions.

12. The method of claim 11, wherein the set of control instructions is selectable by a user.

13. The method of claim 11, wherein a dimmer in communication with the LED driver selects the set of control instructions.

14. The method of claim 11, wherein the LED driver is a two channel LED driver.

15. The method of claim 11, wherein the light fixture is a two channel LED light fixture.

16. The method of claim 11, wherein the first IC board comprises a substrate substantially made of an aluminum material.

17. The method of claim 11, wherein the first IC board comprises an aluminum substrate.

18. The method of claim 11, wherein the encapsulation material is extruded silicon.

19. The method of claim 11, wherein the modular encapsulated lighting system is waterproof.

20. A modular encapsulated lighting system with integrated heat sink, the system comprising:
a light emitting diode (LED);
a first IC board extending in a longitudinal direction from a first end having a first end engagement portion to a second end having a second end engagement portion, the LED disposed on a first IC board surface of the first IC board and presenting a set of LED exposed surfaces, the first IC board comprising an aluminum substrate; and
an encapsulation material disposed on the set of LED exposed surfaces and further disposed on a first IC board surface area surrounding the set of LED exposed surfaces, the encapsulated material comprising extruded silicon;
wherein:
the first end engagement portion of the first IC board is configured to engage a second end engagement portion of a second IC board and the second end engagement portion of the first IC board is configured to engage a first end engagement portion of a second IC board, the second IC board of substantially similar configuration to the first IC board;
the first end engagement portion of the first IC board and the second end engagement of the second IC board form a tongue and groove arrangement when engaged;
the first IC board receives thermal energy from the LED; and
the modular encapsulated lighting system is substantially waterproof.
